(19) United States
(12) Patent Application Publication
(10) Pub. No.: US 2013/0100072 A1
(43) Pub. Date: Apr. 25, 2013

(54) Touch Panel

(71) Applicants: Wintek (China) Technology Ltd., Dongguan City (CN); Wintek Corporation, Taichung City (TW)

(72) Inventors: Hsiao-Hui Liao, Taichung City (TW); Ting-Yu Chang, Kaohsiung City (TW); Ching-Fu Hsu, Taichung City (TW); Wen-Tui Liao, Taichung City (TW); Fa-Chen Wu, Taichung City (TW)

(73) Assignees: WINTEK CORPORATION, Taichung City (TW); WINTEK (CHINA) TECHNOLOGY LTD., Dongguan City (CN)

(21) Appl. No.: 13/655,539

(22) Filed: Oct. 19, 2012

(30) Foreign Application Priority Data
Oct. 20, 2011 (TW) 100138118

(51) Int. Cl. G06F 3/044

(52) U.S. Cl. 345/174

(57) ABSTRACT

A touch panel including a capacitance touch structure and a pressure sensing touch structure is provided. The pressure sensing touch structure includes a first conductive film, a second conductive film, an electric field generator and a spacer structure. The spacer structure is disposed between the first conductive film and the second conductive film. The spacer structure includes a plurality of insulating spacers, a plurality of conductive spacers and a soft medium. The plurality of the conductive spacers and the plurality of the insulating spacers are alternately distributed in the soft medium. The plurality of the conductive spacers and the second conductive film are separated by a gap distance by the plurality of the insulating spacers.

This application claims the benefit of Taiwan application Serial No. 100138118, filed Oct. 20, 2011, the disclosure of which is incorporated by reference herein in its entirety.

### BACKGROUND

1. Technical Field

The invention relates in general to a touch device, and more particularly to a touch panel.

2. Description of the Related Art

From iPhone, Surface to Windows 7, multi-touch is virtually a new man-machine interface which replaces keyboard and mouse. To implement a multi-touch function, touch sensing and control, hardware driver and human machine interface of application programs must be integrated. Most importantly, a due touch panel is indispensable. The application of touch panel covers a wide range such as (1) portable information, consumer electronic and telecommunication products; (2) financial or commercial purpose; (3) industrial purpose; (4) public information purpose.

At present, the products incorporating touch technology have the advantages of multi-touch, long lifespan, and high penetration, and have great potential to become focus products in the next few years. The touch panel senses a capacitance variation resulted from a touching action on the surface of the touch panel. For example, a user may contact the surface of the touch panel with a conductive external object such as a stylus. However, the capacitance variation cannot be resulted from a touching action by an insulating external object. For those users who wear gloves seasonally or habitually, they have to take off a glove before performing a touching action, and this is indeed inconvenient.

### SUMMARY

According to an embodiment, a touch panel including a capacitance touch structure and a pressure sensing touch structure is provided. The capacitance touch structure senses a touching operation according to a capacitance variation resulted from a touching action by a conductive object. The pressure sensing touch structure disposed on a side of the capacitance touch structure senses a touching operation according to a shape variation. The pressure sensing touch structure includes a first conductive film, a second conductive film, an electric field generator and a spacer structure. The electric field generator surrounds the second conductive film for generating a uniform electric field in the second conductive film. The spacer structure is disposed between the first conductive film and the second conductive film. The spacer structure includes a plurality of insulating spacers, a plurality of conductive spacers and a soft medium. The plurality of the conductive spacers and the plurality of the insulating spacers are alternately distributed in the soft medium. The plurality of the conductive spacers and the second conductive film are separated by a gap distance by the plurality of the insulating spacers. The pressure sensing touch structure senses the touching operation according to an electric field variation caused by a variation of the gap distance resulted from a touching action by an external force.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a touch panel according to an embodiment;

FIG. 2 shows a cross-sectional view of a touch panel according to an embodiment;

FIG. 3 shows a schematic diagram of an electrode structure according to an embodiment;

FIG. 4 shows a cross-sectional view of a touch panel according to an embodiment;

FIG. 5 shows a cross-sectional view of a touch panel according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

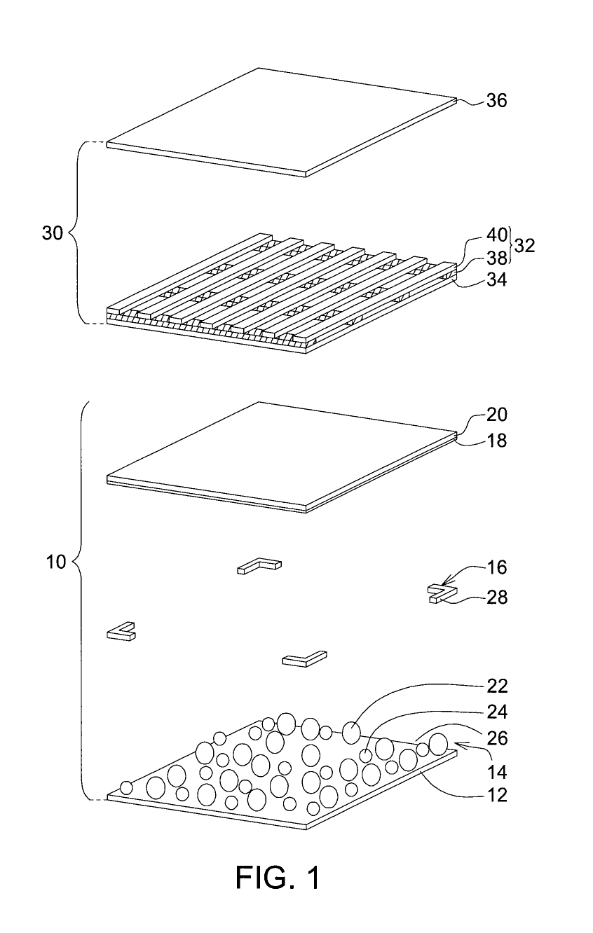

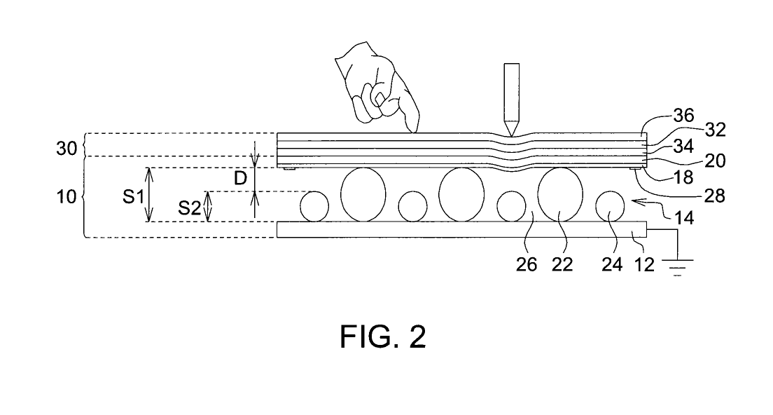

FIG. 1 and FIG. 2 show a schematic diagram and a cross-sectional view of a touch panel, respectively. Referring to FIG. 1, the touch panel includes a first touch structure 10 and a second touch structure 30. The first touch structure 10 is disposed on a touch side farther away from a user, and the second touch structure 30 is disposed on a touch side closer to the user. The first touch structure 10 is a pressure sensing touch structure used for sensing a touching operation according to a shape variation. Thus, an external object, regardless being a conductive object or an insulating object, can be used to operate the first touch structure 10.

Referring to FIG. 1, the first touch structure 10 may include a first conductive film 12, a spacer structure 14, an electric field generator 16, a second conductive film 18 and a first substrate 20. The second conductive film 18 is disposed on a surface of the first substrate 20. The electric field generator 16 is disposed on the second conductive film 18. The spacer structure 14 may be disposed between the first conductive film 12 and the second conductive film 18, wherein the first conductive film 12 and the second conductive film 18 are substantially parallel to each other. In an embodiment, the first conductive film 12 is electrically connected to a reference potential such as a ground potential (FIG. 2). The second conductive film 18 is disposed closer to the second touch structure 30, and the first conductive film 12 is disposed farther away from the second touch structure 30.

Again, referring to FIG. 1, in an embodiment, the electric field generator 16 of the first touch structure 10 is formed by conductive electrode wires 28 surrounding the second conductive film 18. In the embodiment, the conductive electrode wires 28 are respectively arranged at the four corners of the second conductive film 18. A uniform electric field is generated in the second conductive film 18 by applying voltages to the conductive electrode wires 28 of the electric field generator 16 along two diagonal lines. For example, the same voltage is applied to the four corners through the conductive electrode wires 28, so that a uniform electric field is formed in the second conductive film 18.

Referring to FIG. 2, the spacer structure 14 includes a plurality of insulating spacers 22 and a plurality of conductive spacers 24 distributed in a soft medium 26. In embodiments, for example, the insulating spacers 22 and the conductive spacers 24 are spheroidal structures. The insulating spacers 22 have a first largest size S1 of a direction substantially perpendicular to the first conductive film 12. Thus, a gap distance between the first conductive film 12 and the second conductive film 18 may be controlled to be equal to the first largest size S1. The conductive spacers 24 have a second largest size S2 of a direction substantially perpendicular to the first conductive film 12. The first largest size S1 is larger than the second largest size S2. Therefore, the conductive spacers 24 and the second conductive film 18 are separated by a gap distance D by the insulating spacers 22. In addition, since the first conductive film 12 is has a whole plane structure, by controlling the gap distance S1, an electric field coupling effect between the first conductive film 12 and the second conductive film 18 may be reduced to prevent a uniform distribution of an electric field in the second conductive film 18 from interfering by the first conductive film 12.

Moreover, although the gap distance D between the conductive spacers 24 and the second conductive film 18 is smaller than a gap distance between the second conductive film 18 and the first conductive film 12, tan effective capacitance coupling area between the conductive spacers 24 and the second conductive film 18 is smaller than an effective capacitance coupling area between the first conductive film 12 and the second conductive film 18. Therefore, a coupling effect between the conductive spacers 24 and the second conductive film 18 is smaller than that between the first conductive film 12 and the second conductive film 18. The effective capacitance coupling area is an area projected onto the second conductive film 18 from the conductive spacers 24 or the first conductive film 12.

On the other hand, since the gap distance D between the conductive spacers 24 and the second conductive film 18 is smaller than the gap distance S1 between the first conductive film 12 and the second conductive film 18, a tiny shape variation between the conductive spacers 24 and the second conductive film 18 would suffice to activate a touching operation on the first touch structure 10. Consequently, a user will experience smoother control in operating the first touch structure 10.

In an embodiment, the conditions, such as a distribution density, a quantity, a size and so on, of the insulating spacers 22 and conductive spacers 24 are properly determined to achieve superior operation effect. For example, a user may obtain sensitive and accurate response by operating the touch panel with a light force. For example, the first largest size S1: the second largest size S2 is 1.33:1. In an embodiment, the first largest size S1 is 200 μm, preferably. The second largest size S2 is 150 μm, preferably. The gap distance D is 50 μm, preferably. However, embodiments are not limited thereto. Any sizes conformed to the ratio of the first largest size S1 to the second largest size S2 are within the scope of protection of the invention.

The insulating spacers 22 arranged in an interspersed manner provide a uniform supporting force to separate the elements disposed above the insulating spacers 22 from the elements disposed underneath the insulating spacers 22 to prevent the elements from being permanently deformed due to a deteriorated restoring force after a long duration of use.

Examples of materials of the insulating spacers 22 include glass, plastics, oxides and so on. Examples of materials of the conductive spacers 24 include metal, polymer material of high conductivity, indium tin oxide (ITO), indium zinc oxide (IZO), aluminum zinc oxide (AZO), zinc oxide (ZnO), stannic oxide (mono-crystalline SnO). In an embodiment, the soft medium 26 is a dielectric material, whose dielectric constant is substantially greater than 1, including air or silicon oil, for example. The first conductive film 12 and the second conductive film 18 include transparent conductive materials such as polymer material of high conductivity, ITO, IZO, AZO, ZnO, SnO (mono-crystalline SnO) and so on, respectively. The first substrate 20 may include a transparent material such as glass, acrylic, polycarbonate (PC), poly (ethylene terephthalate) (PET), and polymide (PI) and so on.

Again, referring to FIG. 2, the second conductive film 18 is deformed when an external object, such as a stylus illustrated in the diagram, touches the first touch structure 10 and changes the gap distance D between the conductive spacers 24 and the second conductive film 18. Consequently, the distribution of the electric field in the second conductive film 18 is changed and the coordinates of the touch point is obtained from the electric field variation.

Furthermore, to achieve touch effect, the plurality of the insulating spacers 22 and the plurality of the conductive spacers 24 must be alternately disposed such that when a touching operation occurs, the second conductive film 18 can be deformed at any position to form a sensing electric field with the conductive spacers 24. For example, as indicated in FIG. 2, each of the insulating spacers 22 and each of the conductive spacers 24 are arranged alternately. However, the number of the insulating spacers 22 and the conductive spacers 24 to be arranged alternately is not restricted. It may be realized that adjacent two insulating spacers 22 alternate with adjacent two conductive spacers 24; or one insulating spacer 22 alternates with adjacent two conductive spacers 24. Any alternating disposition can be used as long as the second conductive film 18 can be deformed at any position to form an electric field with the conductive spacers 24.

Moreover, during a touching operation, it is not necessary for a touching action to make the second conductive film 18 contacting the conductive spacers 24. A sensing effect can be achieved as long as the gap distance D between the conductive spacers 24 and the second conductive film 18 is changed. In an exemplary embodiment, when a touching action makes the second conductive film 18 contacting with the conductive spacers 24, the uniform distribution of electric field is significantly destroyed, hence intensifying the sensing effect.

The second touch structure 30 includes a second substrate 36, a third substrate 34 and an electrode structure 32. The electrode structure 32 is disposed between the second substrate 36 and the third substrate 34. The third substrate 34 is disposed on another surface of the first substrate 20 of the first touch structure 10. In an embodiment, the electrode structure 32 is disposed between the second substrate 36 and the third substrate 34 to form the second touch structure 30. In addition, after the first touch structure 10 is formed, the second touch structure 30 is disposed on the first substrate 20 of the first touch structure 10 to form a touch panel.

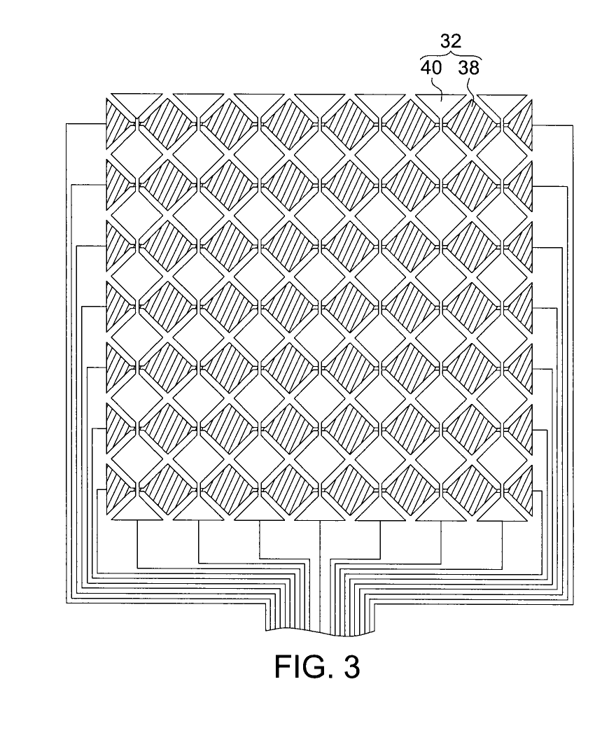

In an embodiment, the second touch structure 30 is a projective capacitance touch structure, and senses a touch action by reading a capacitance variation with the electrode structure 32 disposed between the third substrate 34 and the second substrate 36, wherein the capacitance variation is resulted from a touching action by a conductive stylus or a finger. The electrode structure 32 is not limited to a rectangular pattern layer as illustrated in FIG. 1, and may also be realized by a diamond-shaped pattern layer as illustrated in FIG. 3 or other suitable pattern layers. The electrode structure 32 may comprise a first electrode pattern 38 and a second electrode pattern 40 respectively extending along different directions such as X and Y directions. In one embodiment, the first electrode pattern 38 and the second electrode pattern 40 may be disposed on the same side of an insulating substrate such as the third substrate 34 (FIG. 1), and an insulating spacer (not shown) is disposed at a cross portion between the first electrode pattern 38 and the second electrode pattern 40 to electrically insulate the first electrode pattern 38 and the second electrode pattern 40. In other embodiments, the first electrode pattern 38 and the second electrode pattern 40 may be respectively disposed on opposite sides of an insulating substrate (not shown).

When the external object is a conductive object, a touch action is mainly read with the second touch structure 30. Since the second touch structure 30 is disposed on the touch side of the external object, the conductive external object may operate the touch panel more effectively. No matter the external object is a conductive object or an insulating object, the structural deformation resulted from a touching action on the panel by an external force makes the first touch structure 10 able to sense the touch. Since the second touch structure 30 is disposed above the first touch structure 10 (that is, the second touch structure 30 is disposed on the touch side closer to the user), the sensing effect of the second touch structure 30 is thus increased.

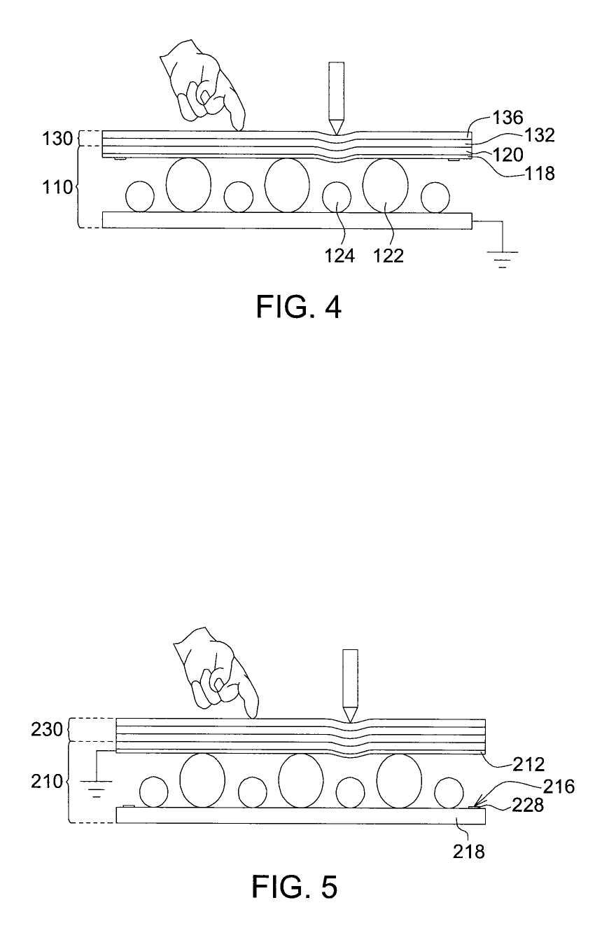

FIG. 4 shows a cross-sectional view of a touch panel according to an embodiment. The touch panel illustrated in FIG. 4 is different from the touch panel illustrated in FIG. 2 in that the third substrate 34 of the touch panel illustrated in FIG. 2 is omitted. In the embodiment, after the first touch structure 110 is formed and the electrode structure 132 is disposed on the second substrate 136 to form the second touch structure 130, the electrode structure 132 and the second substrate 136 are together formed on the surface of the first substrate 120 of the first touch structure 110 facing the second touch structure 130. The second substrate 136 is used as a cover.

FIG. 5 shows a cross-sectional view of a touch panel according to an embodiment. The touch panel illustrated in FIG. 5 is different from the touch panel illustrated in FIG. 2 in that the second conductive film 218 of the first touch structure 210 is disposed farther away from the second touch structure 230, and the first conductive film 212 of the first touch structure 210 is disposed closer to the second touch structure 230. Similar with the touch panel illustrated in FIG. 1, the conductive electrode wires 228 of the electric field generator 216 are disposed at the four corners of the second conductive film 218.

The touch panel disclosed in above embodiments of the invention includes the first touch structure, which senses a touching action according to a shape variation. Therefore, the touch panel may be operated no matter the external object used to touch the touch panel is a conductive object or an insulating object, and the use of the touch panel becomes very convenient to the user. The conditions of the insulating spacers and conductive spacers are properly selected so that superior operation effect can be achieved. The insulating spacers disposed in an interspersed manner provide a uniform supporting force to separate the elements disposed above the insulating spacers from the elements disposed underneath the insulating spacers to prevent the elements from being permanently deformed due to a deteriorated restoring force after a long duration of use. The first touch structure may also be used in association with other touch structure, and may be designed in a versatile and multivariate manner.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A touch panel, comprising:
a capacitance touch structure for sensing a touching operation according to a capacitance variation resulted from a touching action by a conductive object; and
a pressure sensing touch structure disposed on a side of the capacitance touch structure for sensing a touching operation according to a shape variation, wherein the pressure sensing touch structure comprises:
a first conductive film;
a second conductive film;
an electric field generator surrounding the second conductive film for generating a uniform electric field in the second conductive film; and
a spacer structure disposed between the first conductive film and the second conductive film, wherein the spacer structure comprises:
a plurality of insulating spacers;
a plurality of conductive spacers; and
a soft medium in which the plurality of the conductive spacers and the plurality of the insulating spacers are alternately distributed, wherein the plurality of the conductive spacers and the second conductive film are separated by a gap distance by the plurality of the insulating spacers;
wherein during a touching operation, the pressure sensing touch structure senses the touching operation according to an electric field variation caused by a variation of the gap distance resulted from a touching action by an external force.

2. The touch panel according to claim 1, wherein the first conductive film is substantially parallel to the second conductive film, the insulating spacers have a first largest size of a direction substantially perpendicular to the first conductive film, the plurality of the conductive spacers has a second largest size of a direction substantially perpendicular to the first conductive film, the first largest size is larger than the second largest size.

3. The touch panel according to claim 2, wherein the first largest size: the second largest size is 1.33:1.

4. The touch panel according to claim 1, wherein the gap distance is 50 μm.

5. The touch panel according to claim 1, wherein the pressure sensing touch structure is disposed on a touch side farther away from a user, the capacitance touch structure is disposed on a touch side closer to the user.

6. The touch panel according to claim 1, wherein an effective capacitance coupling area between the plurality of the conductive spacers and the second conductive film is smaller than an effective capacitance coupling area between the first conductive film and the second conductive film, and the effective capacitance coupling area is an area projected onto the second conductive film from the plurality of the conductive spacers or the first conductive film.

7. The touch panel according to claim 1, wherein the second conductive film is disposed farther away from the capacitance touch structure, the first conductive film is disposed closer to the capacitance touch structure.

8. The touch panel according to claim 1, wherein the second conductive film is disposed closer to the capacitance touch structure, and the first conductive film is disposed farther away from the capacitance touch structure.

9. The touch panel according to claim 1, wherein the pressure sensing touch structure further comprises a first substrate, and the second conductive film is disposed on a surface of the first substrate.

10. The touch panel according to claim 9, wherein the capacitance touch structure comprises:
a second substrate;
a third substrate; and
an electrode structure disposed between the second substrate and the third substrate, wherein the third substrate is disposed on another surface of the first substrate.

11. The touch panel according to claim 9, wherein the capacitance touch structure comprises:
an electrode structure; and
a second substrate, wherein the electrode structure and the second substrate are together formed on another surface of the first substrate of the first touch structure, and the second substrate is used as a cover.
